(19) United States
(12) Patent Application Publication
(10) Pub. No.: US 2016/0092353 A1
(43) Pub. Date: Mar. 31, 2016

(54) ESTABLISHING COLD STORAGE POOLS FROM AGING MEMORY

(71) Applicants: Robert C. Swanson, Olympia, WA (US); Robert W. Cone, Portland, OR (US); Brian R. Bennett, Laguna Niguel, CA (US); Vladimir Matveyenko, Fountain Valley, CA (US); Paul D. Herring, Laguna Beach, CA (US); Jordan A. Horwich, Irvine, CA (US); Tuan M. Quach, Fullerton, CA (US); Cuong D. Dinh, Fountain Valley, CA (US); Paul M. Leung, Bellflower, CA (US); Luis E. Valdez, Santa Ana, CA (US); Joseph Hamann, Orange, CA (US); Russell A. Hamann, Orange, CA (US); Michael P. Pham, Garden Grove, CA (US); Caleb C. Molitoris, Irvine, CA (US); Kervin T. Ngo, Anaheim, CA (US); Cory Li, Newport Beach, CA (US); Ola Fadiran, Santa Ana, CA (US); Jason R. Ng, Hacienda Heights, CA (US); Richard I. Guerin, San Juan Capistrano, CA (US); Jay H. Danver, Costa Mesa, CA (US); Chris Kun K. Cheung, Irvine, CA (US); Satish R. Natla, Irvine, CA (US); Rodel I. Cruz-Herrera, Diamond Bar, CA (US)

(72) Inventors: Robert C. Swanson, Olympia, WA (US); Robert W. Cone, Portland, OR (US); Brian R. Bennett, Laguna Niguel, CA (US); Vladimir Matveyenko, Fountain Valley, CA (US); Paul D. Herring, Laguna Beach, CA (US); Jordan A. Horwich, Irvine, CA (US); Tuan M. Quach, Fullerton, CA (US); Cuong D. Dinh, Fountain Valley, CA (US); Paul M. Leung, Bellflower, CA (US); Luis E. Valdez, Santa Ana, CA (US); Joseph Hamann, Orange, CA (US); Russell A. Hamann, Orange, CA (US); Michael P. Pham, Garden Grove, CA (US); Caleb C. Molitoris, Irvine, CA (US); Kervin T. Ngo, Anaheim, CA (US); Cory Li, Newport Beach, CA (US); Ola Fadiran, Santa Ana, CA (US); Jason R. Ng, Hacienda Heights, CA (US); Richard I. Guerin, San Juan Capistrano, CA (US); Jay H. Danver, Costa Mesa, CA (US); Chris Kun K. Cheung, Irvine, CA (US); Satish R. Natla, Irvine, CA (US); Rodel I. Cruz-Herrera, Diamond Bar, CA (US)

(21) Appl. No.: 14/496,773

(22) Filed: Sep. 25, 2014

(51) Int. Cl. G06F 12/06; G06F 12/12; G06F 11/30

(52) U.S. Cl. CPC G06F 12/0638; G06F 12/0646; G06F 11/3037; G06F 12/123; G06F 2212/205; G06F 2212/7206; G06F 2212/69

(57) ABSTRACT

Systems and methods may provide for detecting a pending write operation directed to a target memory region and determining whether the target memory region satisfies a degradation condition in response to the pending write operation. Additionally, the target memory region may be automatically reconfigured as a cold storage region if the target memory region satisfies the degradation condition. In one example, determining whether the target memory region satisfies the degradation condition includes updating the number of write operations directed to the target memory region based on the pending write operation and comparing the number of write operations to an offset value, wherein the degradation condition is satisfied if the number of write operations exceeds the offset value.

### TECHNICAL FIELD

Embodiments generally relate to memory systems. More particularly, embodiments relate to establishing cold storage pools from aging memory.

### BACKGROUND

Cold storage may be used in data systems to house infrequently accessed data such as backup data. In a tiered memory system, cold storage may typically be implemented in a medium such as tape, which may have a fixed storage capacity and other inflexible operating constraints.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an approach to establishing a cold storage pool from aging memory according to an embodiment;

FIG. 2 is a block diagram of an example of a memory architecture according to an embodiment;

FIG. 3 is a flowchart of an example of a method of operating a memory controller according to an embodiment;

FIG. 4 is a block diagram of an example of a memory controller according to an embodiment; and

FIGS. 5A and 5B are block diagrams of examples of cold storage-based computing systems according to embodiments.

### DESCRIPTION OF EMBODIMENTS

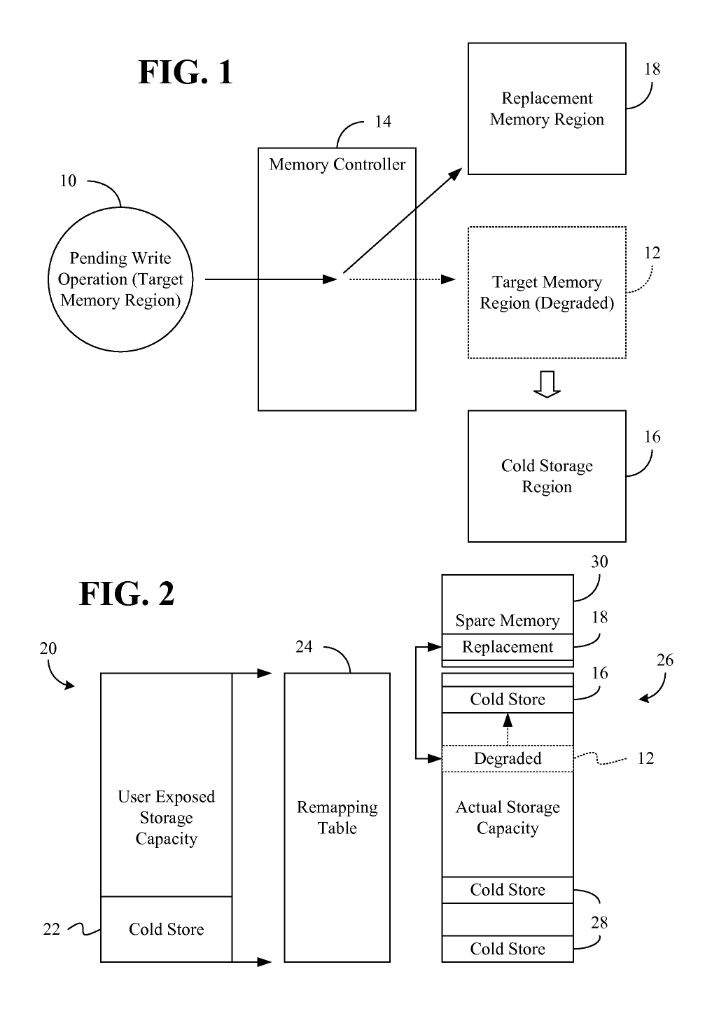

Turning now to FIG. 1, a scenario is shown in which a pending write operation 10 is directed to a target memory region 12 (e.g., system memory operating in a double data rate/DDR volatile mode) via a memory controller 14. The pending write operation 10 may be the result of, for example, a data processing, refresh and/or integrity (e.g., protection from “neighbor” write disturbances) activity in a cold storage-based computing system. In the illustrated example, the target memory region 12 is degraded due to, for example, aging and/or a relatively high number of write operations (e.g., “writes”) being performed on the target memory region 12 over time. In this regard, the target memory region 12 may support a limited number of writes before it loses the ability to retain data. Rather than continuing to write data to the target memory region 12 once it has reached the degraded or partially degraded state, the illustrated memory controller 14 automatically reconfigures the target memory region 12 as a cold storage region 16 and copies and/or re-directs the pending write operation 10 to a replacement memory region 18. Such an approach may provide for a flexible cold storage pool that grows in capacity as memory ages, wherein the cold storage pool may be used to store large amounts of infrequently changing data such as, for example, social networking media content.

FIG. 2 shows a memory architecture in which a user exposed storage capacity 20 (e.g., logical and/or virtual address space) includes a contiguous cold storage pool 22 and is mapped via a remapping table 24 (e.g., of a memory controller, not shown) to an actual storage capacity 26 (e.g., memory device, physical address space). In the illustrated example, the cold storage pool 22 maps to various non-contiguous cold storage regions 28, 16 in the actual storage capacity 26 and the degraded target memory region 12 is reconfigured as the cold storage region 16, as already discussed. In one example, the actual storage capacity 26 includes phase change memory (PCM) that may be converted from one mode of operation to another via rapid heat changes that shift the material of the PCM between crystalline and amorphous states.

Of particular note is that PCM may have relatively low access latencies that render it suitable for volatile (e.g., second level memory) storage, as well as non-volatile (e.g., persistent) and block storage (e.g., solid state disk/SSD) purposes. Other techniques such as, for example, spin-transfer torque, memristors, etc., may be used to reconfigure the target memory region 12 as the cold storage region 16. Moreover, the replacement memory region 18 may be maintained in spare memory 30 of the actual storage capacity 26. Additionally, an “auto-cold storage” option may enable the memory controller to copy the least utilized memory regions (i.e., already written data) of the actual storage capacity 26 to other memory regions nearing the end of their lifetime.

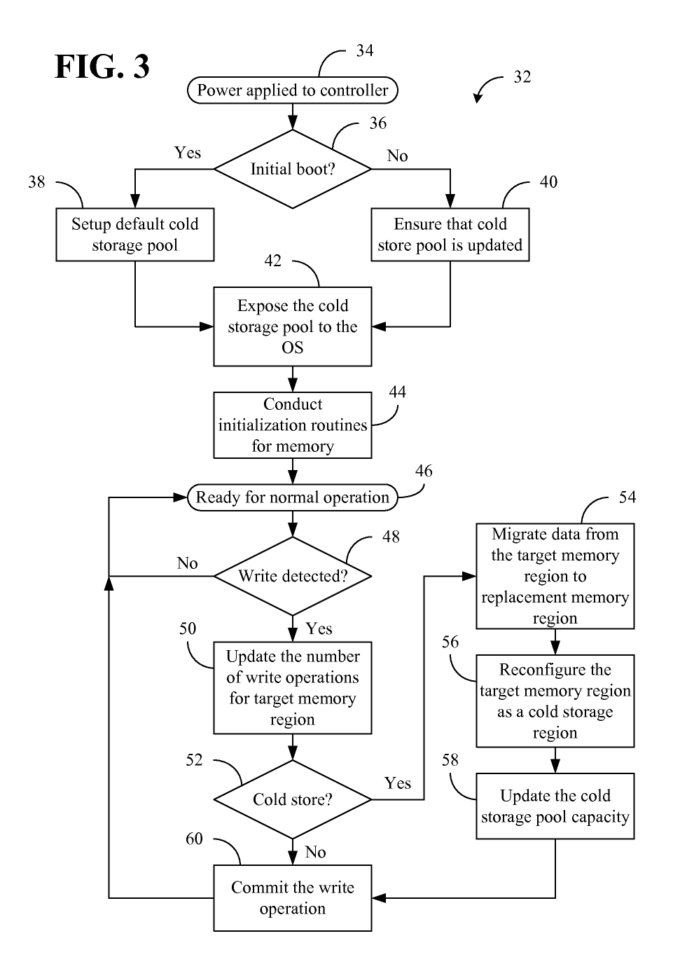

Turning now to FIG. 3, a method 32 of operating a memory controller such as, for example, the memory controller 14 (FIG. 1) is shown. The method 32 may be implemented as one or more modules or related components in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 32 may be written in any combination of one or more programming languages, including an object oriented programming language such as JAVA, SMALLTALK, C++ or the like and conventional procedural programming languages, such as the “C” programming language or similar programming languages.

Upon the application of power to the memory controller at block 34, illustrated processing block 36 determines whether an initial boot of the memory controller is taking place. If so, a default cold storage pool may be setup at block 38, wherein the capacity of the cold storage pool may be user and/or system defined according to one or more tiered memory hierarchy considerations. Otherwise, block 40 may ensure that the cold storage pool is updated. The cold storage pool may be exposed to an operating system (OS) 42, wherein the OS may generally use the cold storage pool to house infrequently accessed data such as, for example, backup images of critical files that do not change often (e.g., basic input/output system/BIOS, OS loader, etc.), pictures, videos, etc. Block 42 might include, for example, issuing a cold storage command during pre-OS operations such as BIOS routines to ensure that the cold storage pool is available when the OS gains control of the computing system. Block 44 may conduct various memory initialization routines such as determining a degradation offset value (discussed in greater detail below), setting up the various pools of memory and current state, and so forth.

Once the computing system is ready for normal operation at block 46, illustrated processing block 48 determines whether a write operation has been detected. The write operation may include, for example, a data processing write, a refresh write, a disturbance integrity write, and so forth. If a write is not detected, the illustrated method 32 enters a wait state for the next write operation. If a write is detected, the number of write operations for the target memory region may be updated at block 50. Block 52 may determine whether the target memory region satisfies a degradation condition and is eligible for migration to the cold storage pool. Block 52 may include, for example, comparing the number of write operations to a degradation offset value, which may be accounted for as follows.

The manufacturer of the memory device may set a safe write value such as “MFG_absolute_write”, wherein the offset value may be defined as “write_cold_store_offset” according to the following expression:

write_cold_store_offset=MFG_absolute_write−cold_storage_value

Where “cold_storage_value” is a number of safe write operations before the memory is deemed degraded and potentially imminent for failure. Thus, if the total number of write operations (e.g., data processing, refresh, disturbance integrity) directed to the target memory region exceeds the offset value, the degradation condition is satisfied and the target memory region may be deemed eligible for migration to the cold store pool. In such a case, processing block 54 may migrate data from the target memory region to a replacement memory region, wherein the target memory region may be automatically reconfigured as a cold storage region at block 56. Block 56 may include changing the mode of operation for the target memory region from, for example, a volatile (e.g., non-persistent, transparent to applications) mode to a non-volatile (e.g., persistent, explicitly exposed to applications) mode. In this regard, the memory device containing the target memory region may include, for example, a phase change material that is capable of being reconfigured between volatile, non-volatile and block storage (e.g., supporting legacy file systems) modes on a memory block-by-memory block basis. Without loss of generality, this reconfiguring may be done via a BIOS System Management routine, driver, etc. Processing block 58 may update the cold storage pool capacity by exposing the new cold storage region to the OS and block 60 may commit the write operation to the replacement memory region.

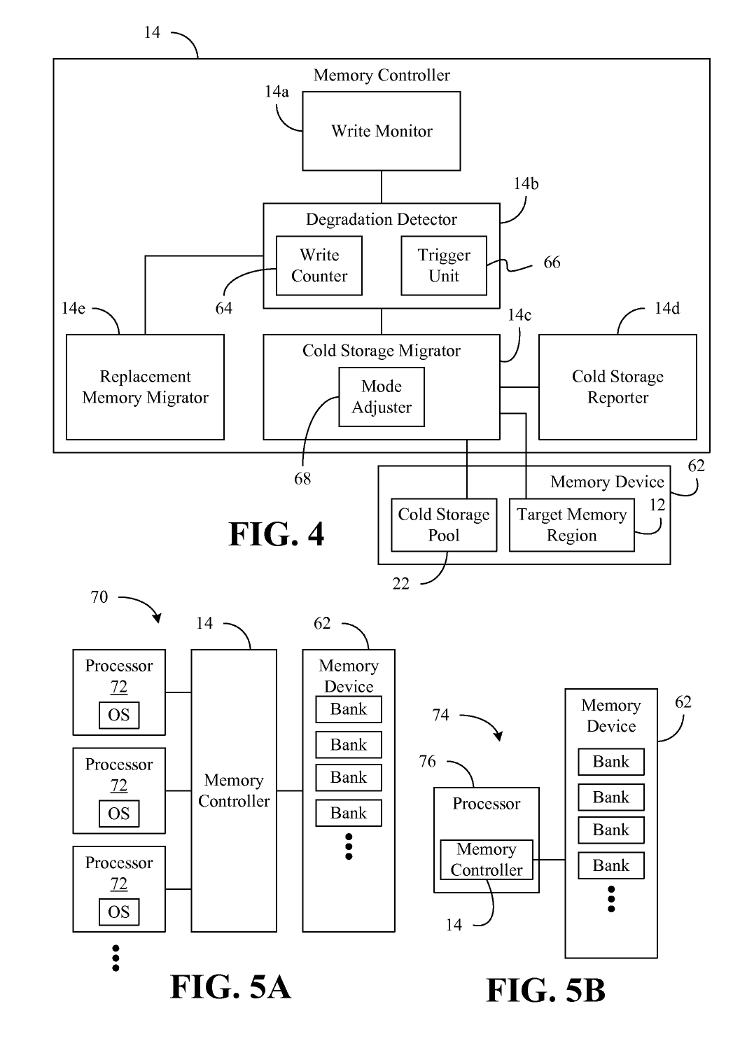

Turning now to FIG. 4, one example of the memory controller 14 (14a-14e) is shown in greater detail. The memory controller 14 may generally implement and/or conduct one or more aspects of the method 32 (FIG. 3), already discussed. More particularly, the memory controller 14 may include a write monitor 14a to detect a pending write operation (e.g., data processing write, refresh write, disturbance integrity write) directed to the target memory region 12 in a memory device 62 (e.g., PCM). Additionally, a degradation detector 14b may be coupled to the write monitor 14a, wherein the degradation detector 14b may determine whether the target memory region 12 satisfies a degradation condition in response to the pending write operation. The illustrated memory controller 14 also includes a cold storage migrator 14c coupled to the degradation detector 14b and the target memory region 12. The cold storage migrator 14c may reconfigure the target memory region 12 as a cold storage region in the cold storage pool 22 if the target memory region 12 satisfies the degradation condition.

In one example, the degradation detector 14b includes a write counter 64 to update the number of write operations directed to the target memory region 12 based on the pending write operation. The degradation detector 14b may also include a trigger unit 66 to compare the number of write operations to an offset value, wherein the degradation condition is satisfied if the number of write operations exceeds the offset value.

Additionally, a cold storage reporter 14d may expose the newly created cold storage region to the OS as part of the contiguous cold storage pool 22. Moreover, the memory controller 14 may include a mode adjuster 68 to change the mode of operation of the target memory region 12 from the volatile mode to the non-volatile mode in order to re-configure the target memory region 12 as the cold storage region. In one example, the memory controller 14 also includes a replacement memory migrator 14e coupled to the degradation detector 14b, wherein the replacement memory migrator 14e re-maps the pending write operation to a replacement memory region if the target memory region 12 satisfies the degradation condition.

FIGS. 5A and 5B demonstrate various cold storage-based computing systems that may benefit from the techniques described herein. For example, FIG. 5A shows a computing system 70 having a plurality of processors 72 that share the memory controller 14 and access the memory device 62. The computing system 70 may therefore be suitable for deployment as a datacenter server in rack scale architecture where the plurality of processors 72 share the cold storage pool managed by the memory controller 14. In such a case, the OS's might use the cold storage pool to house, for example, backup images of critical files that do not change often (e.g., BIOS, OS loader, etc.), social networking data, and so forth.

FIG. 5B, on the other hand, shows a computing system 74 in which the memory controller 14 is integrated into a single processor 76 that accesses the memory device 62. The computing system 74 may therefore be suitable for deployment as a client computing system (e.g., desktop computer, notebook computer, tablet computer, convertible tablet, smart phone, wearable computer, personal digital assistant/PDA, media player). In such a case, the OS might use the cold storage pool to house local pictures, videos, etc., for a particular end user. The banks and/or modules of the memory device 62 may be incorporated, for example, into a single inline memory module (SIMM), dual inline memory module (DIMM), small outline DIMM (SODIMM), and so on, depending on the form factor of the computing systems 70, 74. Additionally, through simple networking in a household, the sum of the cold storage pools of all computer systems in the home may create a large, continually growing global storage pool. Such an approach may be especially useful for handhelds and smaller form factor devices, as well as phones.

### ADDITIONAL NOTES AND EXAMPLES

Example 1 may include a cold storage-based computing system, comprising a memory device including a target memory region, a plurality of processors, and a shared memory controller coupled to the plurality of processors and the memory device. The shared memory device may include a write monitor to detect a pending write operation directed to the target memory region, a degradation detector coupled to the write monitor, the degradation detector to determine whether the target memory region satisfies a degradation condition in response to the pending write operation, and a cold storage migrator coupled to the degradation detector and the target memory region, the cold storage migrator to reconfigure the target memory region as a cold storage region if the target memory region satisfies the degradation condition.

Example 2 may include the system of Example 1, wherein the degradation detector includes a write counter to update a number of write operations directed to the target memory region based on the pending write operation, and a trigger unit to compare the number of write operations to an offset value, wherein the degradation condition is to be satisfied of the number of write operations exceeds the offset value.

Example 3 may include the system of Example 1, wherein the shared memory controller further includes a cold storage reporter coupled to the cold storage migrator, the cold storage reporter to expose the cold storage region to an operating system as part of a contiguous cold storage pool.

Example 4 may include the system of Example 1, wherein the cold storage migrator includes a mode adjuster to change a mode of operation for the target memory region from a volatile mode to a non-volatile mode.

Example 5 may include the system of Example 1, wherein the write monitor is to detect one or more of a data processing write, a refresh write or a disturbance integrity write.

Example 6 may include the system of any one of Examples 1 to 5, wherein the shared memory controller further includes a replacement memory migrator coupled to the degradation detector, the replacement memory migrator to re-map the pending write operation to a replacement memory region if the target memory region satisfies the degradation condition.

Example 7 may include a method of operating a memory controller, comprising detecting a pending write operation directed to a target memory region, determining whether the target memory region satisfies a degradation condition in response to the pending write operation, and reconfiguring the target memory region as a cold storage region if the target memory region satisfies the degradation condition.

Example 8 may include the method of Example 7, wherein determining whether the target memory region satisfies the degradation condition includes updating a number of write operations directed to the target memory region based on the pending write operation, and comparing the number of write operations to an offset value, wherein the degradation condition is satisfied if the number of write operations exceeds the offset value.

Example 9 may include the method of Example 7, further including exposing the cold storage region to an operating system as part of a contiguous cold storage pool.

Example 10 may include the method of Example 7, wherein reconfiguring the target memory region includes changing a mode of operation for the target memory region from a volatile mode to a non-volatile mode.

Example 11 may include the method of Example 7, wherein detecting the pending write operation includes detecting one or more of a data processing write, a refresh write or a disturbance integrity write.

Example 12 may include the method of any one of Examples 7 to 11, further including re-mapping the pending write operation to a replacement memory region if the target memory region satisfies the degradation condition.

Example 13 may include at least one computer readable storage medium comprising a set of instructions which, when executed a memory controller, cause the memory controller to detect a pending write operation directed to a target memory region, determine whether the target memory region satisfies a degradation condition in response to the pending write operation, and reconfigure the target memory region as a cold storage region if the target memory region satisfies the degradation condition.

Example 14 may include the at least one computer readable storage medium of Example 13, wherein the instructions, when executed, cause the memory controller to update a number of write operations directed to the target memory region based on the pending write operation, and compare the number of write operations to an offset value, wherein the degradation condition is to be satisfied if the number of write operations exceeds the offset value.

Example 15 may include the at least one computer readable storage medium of Example 13, wherein the instructions, when executed, cause the memory controller to expose the cold storage region to an operating system as part of a contiguous cold storage pool.

Example 16 may include the at least one computer readable storage medium of Example 13, wherein the instructions, when executed, cause the memory controller to change a mode of operation for the target memory region from a volatile mode to a non-volatile mode to reconfigure the target memory region.

Example 17 may include the at least one computer readable storage medium of Example 13, wherein one or more of a data processing write, a refresh write or a disturbance integrity write are detected.

Example 18 may include the at least one computer readable storage medium of any one of Examples 13 to 17, wherein the instructions, when executed, cause the memory controller to re-map the pending write operation to a replacement memory region if the target memory region satisfies the degradation condition.

Example 19 may include a memory controller comprising a write monitor to detect a pending write operation directed to a target memory region, a degradation detector coupled to the write monitor, the degradation detector to determine whether the target memory region satisfies a degradation condition in response to the pending write operation, and a cold storage migrator coupled to the degradation detector and the target memory region, the cold storage migrator to reconfigure the target memory region as a cold storage region if the target memory region satisfies the degradation condition.

Example 20 may include the memory controller of Example 19, wherein the degradation detector includes a write counter to update a number of write operations directed to the target memory region based on the pending write operation, and a trigger unit to compare the number of write operations to an offset value, wherein the degradation condition is to be satisfied if the number of write operations exceeds the offset value.

Example 21 may include the memory controller of Example 19, further including a cold storage reporter coupled to the cold storage migrator, the cold storage reporter to expose the cold storage region to an operating system as part of a contiguous cold storage pool.

Example 22 may include the memory controller of Example 19, wherein the cold storage migrator includes a mode adjuster to change a mode of operation for the target memory region from a volatile mode to a non-volatile mode.

Example 23 may include the memory controller of Example 19, wherein the write monitor is to detect one or more of a data processing write, a refresh write or a disturbance integrity write.

Example 24 may include the memory controller of any one of Examples 19 to 23, further including a replacement memory migrator coupled to the degradation detector, the replacement memory migrator to re-map the pending write operation to a replacement memory region if the target memory region satisfies the degradation condition.

Example 25 may include a memory controller comprising means for performing the method of any of Examples 7 to 12, in any combination or sub-combination thereof.

Thus, techniques described herein may enable a tiered usage of memory as it decays due to write activity. Such an approach may be particularly useful for backend applications such as social networking datacenters that provide fast access to cold storage. Moreover, an auto-cold storage option may copy the least utilized memory regions to memory nearing the end of its lifetime.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A cold storage-based computing system, comprising:
a memory device including a target memory region;
a plurality of processors;
a shared memory controller coupled to the plurality of processors and the memory device, the shared memory controller including:
a write monitor to detect a pending write operation directed to the target memory region,
a degradation detector coupled to the write monitor, the degradation detector to determine whether the target memory region satisfies a degradation condition in response to the pending write operation; and
a cold storage migrator coupled to the degradation detector and the target memory region, the cold storage migrator to reconfigure the target memory region as a cold storage region if the target memory region satisfies the degradation condition.

2. The system of claim 1, wherein the degradation detector includes:
a write counter to update a number of write operations directed to the target memory region based on the pending write operation; and
a trigger unit to compare the number of write operations to an offset value, wherein the degradation condition is to be satisfied of the number of write operations exceeds the offset value.

3. The system of claim 1, wherein the shared memory controller further includes a cold storage reporter coupled to the cold storage migrator, the cold storage reporter to expose the cold storage region to an operating system as part of a contiguous cold storage pool.

4. The system of claim 1, wherein the cold storage migrator includes a mode adjuster to change a mode of operation for the target memory region from a volatile mode to a non-volatile mode.

5. The system of claim 1, wherein the write monitor is to detect one or more of a data processing write, a refresh write or a disturbance integrity write.

6. The system of claim 1, wherein the shared memory controller further includes a replacement memory migrator coupled to the degradation detector, the replacement memory migrator to re-map the pending write operation to a replacement memory region if the target memory region satisfies the degradation condition.

7. A method of operating a memory controller, comprising:
detecting a pending write operation directed to a target memory region;
determining whether the target memory region satisfies a degradation condition in response to the pending write operation; and
reconfiguring the target memory region as a cold storage region if the target memory region satisfies the degradation condition.

8. The method of claim 7, wherein determining whether the target memory region satisfies the degradation condition includes:
updating a number of write operations directed to the target memory region based on the pending write operation; and
comparing the number of write operations to an offset value, wherein the degradation condition is satisfied if the number of write operations exceeds the offset value.

9. The method of claim 7, further including exposing the cold storage region to an operating system as part of a contiguous cold storage pool.

10. The method of claim 7, wherein reconfiguring the target memory region includes changing a mode of operation for the target memory region from a volatile mode to a non-volatile mode.

11. The method of claim 7, wherein detecting the pending write operation includes detecting one or more of a data processing write, a refresh write or a disturbance integrity write.

12. The method of claim 7, further including re-mapping the pending write operation to a replacement memory region if the target memory region satisfies the degradation condition.

13. At least one computer readable storage medium comprising a set of instructions which, when executed by a memory controller, cause the memory controller to:
detect a pending write operation directed to a target memory region;
determine whether the target memory region satisfies a degradation condition in response to the pending write operation; and
reconfigure the target memory region as a cold storage region if the target memory region satisfies the degradation condition.

14. The at least one computer readable storage medium of claim 13, wherein the instructions, when executed, cause the memory controller to:
update a number of write operations directed to the target memory region based on the pending write operation; and
compare the number of write operations to an offset value, wherein the degradation condition is to be satisfied if the number of write operations exceeds the offset value.

15. The at least one computer readable storage medium of claim 13, wherein the instructions, when executed, cause the memory controller to expose the cold storage region to an operating system as part of a contiguous cold storage pool.

16. The at least one computer readable storage medium of claim 13, wherein the instructions, when executed, cause the memory controller to change a mode of operation for the target memory region from a volatile mode to a non-volatile mode to reconfigure the target memory region.

17. The at least one computer readable storage medium of claim 13, wherein one or more of a data processing write, a refresh write or a disturbance integrity write are detected.

18. The at least one computer readable storage medium of claim 13, wherein the instructions, when executed, cause the memory controller to re-map the pending write operation to a replacement memory region if the target memory region satisfies the degradation condition.

19. A memory controller, comprising:
a write monitor to detect a pending write operation directed to a target memory region;
a degradation detector coupled to the write monitor, the degradation detector to determine whether the target memory region satisfies a degradation condition in response to the pending write operation; and
a cold storage migrator coupled to the degradation detector and the target memory region, the cold storage migrator to reconfigure the target memory region as a cold storage region if the target memory region satisfies the degradation condition.

20. The memory controller of claim 19, wherein the degradation detector includes:
a write counter to update a number of write operations directed to the target memory region based on the pending write operation; and
a trigger unit to compare the number of write operations to an offset value, wherein the degradation condition is to be satisfied if the number of write operations exceeds the offset value.

21. The memory controller of claim 19, further including a cold storage reporter coupled to the cold storage migrator, the cold storage reporter to expose the cold storage region to an operating system as part of a contiguous cold storage pool.

22. The memory controller of claim 19, wherein the cold storage migrator includes a mode adjuster to change a mode of operation for the target memory region from a volatile mode to a non-volatile mode.

23. The memory controller of claim 19, wherein the write monitor is to detect one or more of a data processing write, a refresh write or a disturbance integrity write.

24. The memory controller of claim 19, further including a replacement memory migrator coupled to the degradation detector, the replacement memory migrator to re-map the pending write operation to a replacement memory region if the target memory region satisfies the degradation condition.
